(19) United States
(12) Patent Application Publication
(10) Pub. No.: US 2012/0265691 A1
(43) Pub. Date: Oct. 18, 2012

(54) Visualizing and Managing Complex Scheduling Constraints

(75) Inventors: Srinivas Chowdhury, Austin, TX (US); Scott Stephen Dickerson, Austin, TX (US); John Mark Hartel, Austin, TX (US); Edward D. Whitehead, (US)

(73) Assignee: International Business Machines Corporation, Armonk, NY (US)

(21) Appl. No.: 13/088,660

(22) Filed: Apr. 18, 2011

(51) Int. Cl. G06Q 10/00

(52) U.S. Cl. 705/301

(57) ABSTRACT

An approach is provided in which a project task is retrieved from a nonvolatile data store with the project task corresponding to a configuration change management project. A set of constraints that are retrieved from a change and configuration management database (CCMDB) are identified with each of the constraints being associated with the retrieved project task. A proposed time window is also retrieved with the proposed time window being a time period in which the retrieved task is tentatively scheduled to be performed. Constraint exception values are also retrieved with the exception values corresponding to some of the identified constraints. The constraint values are compared with the proposed time window and with the retrieved constraint exceptions resulting in a set of status values corresponding to the constraints. The constraints and their corresponding status values are then displayed to a user on a display device.

### BACKGROUND

The present invention relates to an approach that identifies scheduling constraints, both inclusive and exclusive, in a change and configuration management system.

Change Management is an IT Service Management discipline. A combination of skills, assets and methods are used to help ensure success in implementing ITIL best practices in clients' Service Management programs. The objective of Change Management in this context is to ensure that standardized methods and procedures are used in handling changes to control an organization's IT infrastructure. In this manner, Change Management minimizes the number and impact of any related incidents upon service. Changes in the IT infrastructure may arise reactively in response to problems or externally imposed requirements, e.g. legislative changes, or proactively from seeking improved efficiency and effectiveness or to enable or reflect business initiatives, or from programs, projects or service improvement initiatives. Change Management can ensure standardized methods, processes and procedures which are used for all changes, facilitate efficient and prompt handling of all changes, and maintain the proper balance between the need for change and the potential detrimental impact of changes.

### BRIEF SUMMARY

According to one disclosed embodiment, an approach is provided in which a project task is retrieved from a nonvolatile data store with the project task corresponding to a configuration change management project. A set of constraints that are retrieved from a change and configuration management database (CCMDB) are identified with each of the constraints being associated with the retrieved project task. A proposed time window is also retrieved with the proposed time window being a time period in which the retrieved task is tentatively scheduled to be performed. Constraint exception values are also retrieved with the exception values corresponding to some of the identified constraints. The constraint values are compared with the proposed time window and with the retrieved constraint exceptions resulting in a set of status values corresponding to the constraints. The constraints and their corresponding status values are then displayed to a user on a display device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing data components analyzed from a Change and Configuration Management Database (CCMDB) to enable a hierarchical resource constraint enablement widget displayed to a user;

FIG. 4 is an example screen diagram of the hierarchical resource constraint enablement widget;

FIG. 5 is a flowchart showing the high level logic performed by the hierarchical resource constraint enablement widget;

FIG. 6 is a flowchart showing the logic used to identify constraints within the hierarchical resource constraint enablement widget;

FIG. 7 is a flowchart showing the logic used to analyze constraints performed by the hierarchical resource constraint enablement widget; and

FIG. 8 is a flowchart showing the logic used to handle constraint exceptions within the hierarchical resource constraint enablement widget.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

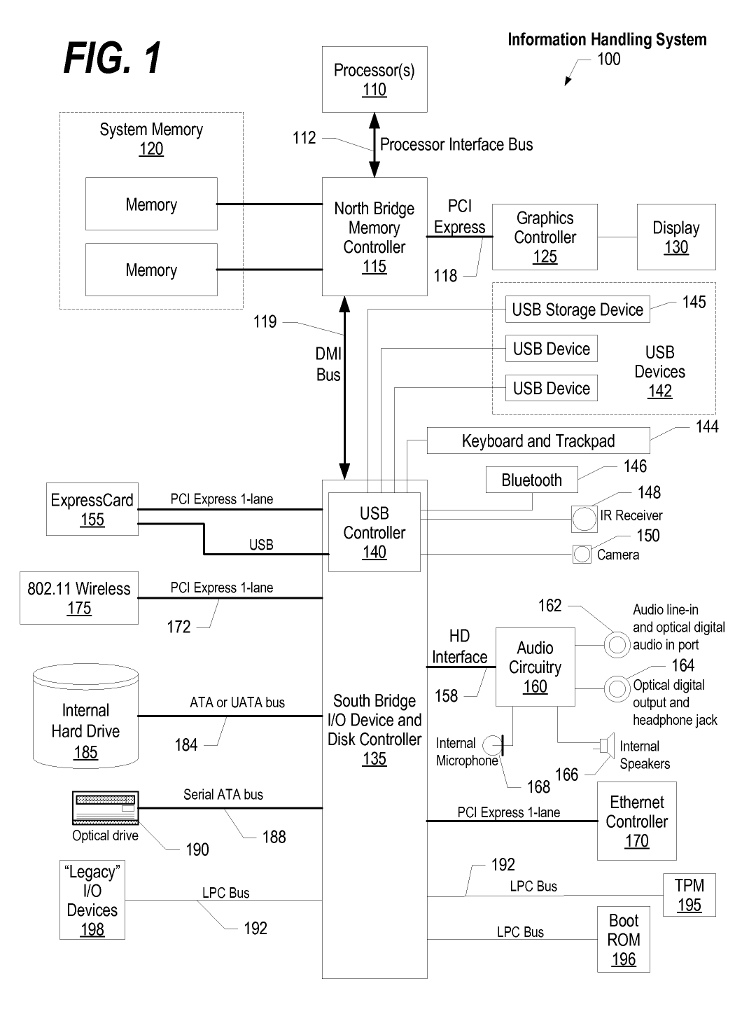

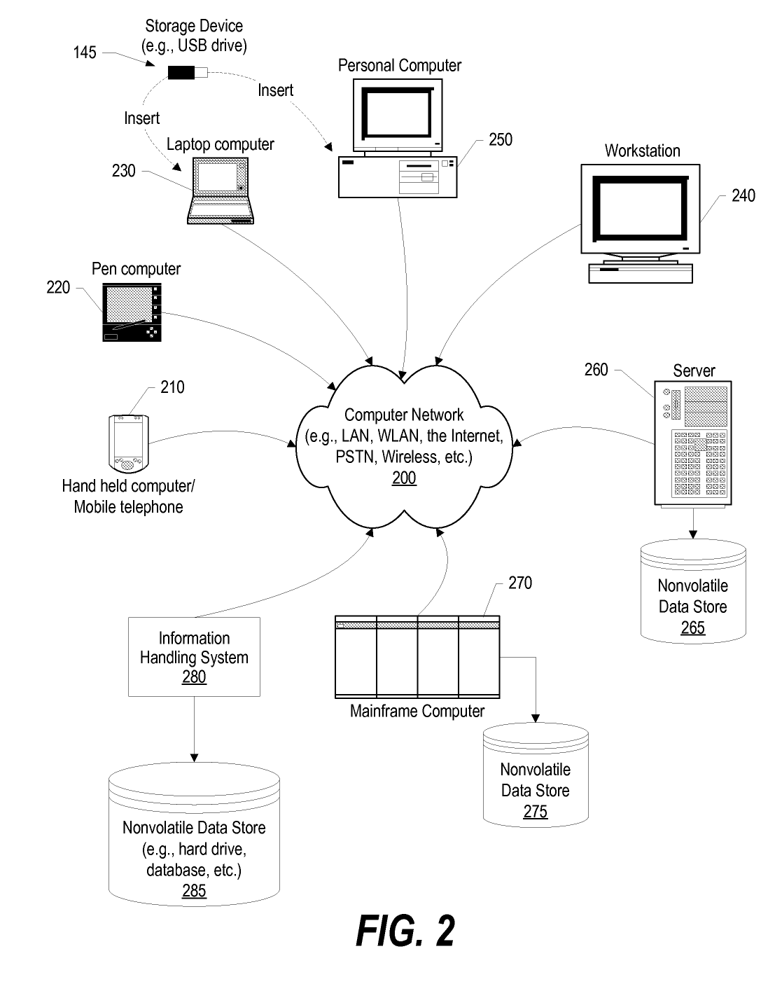

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

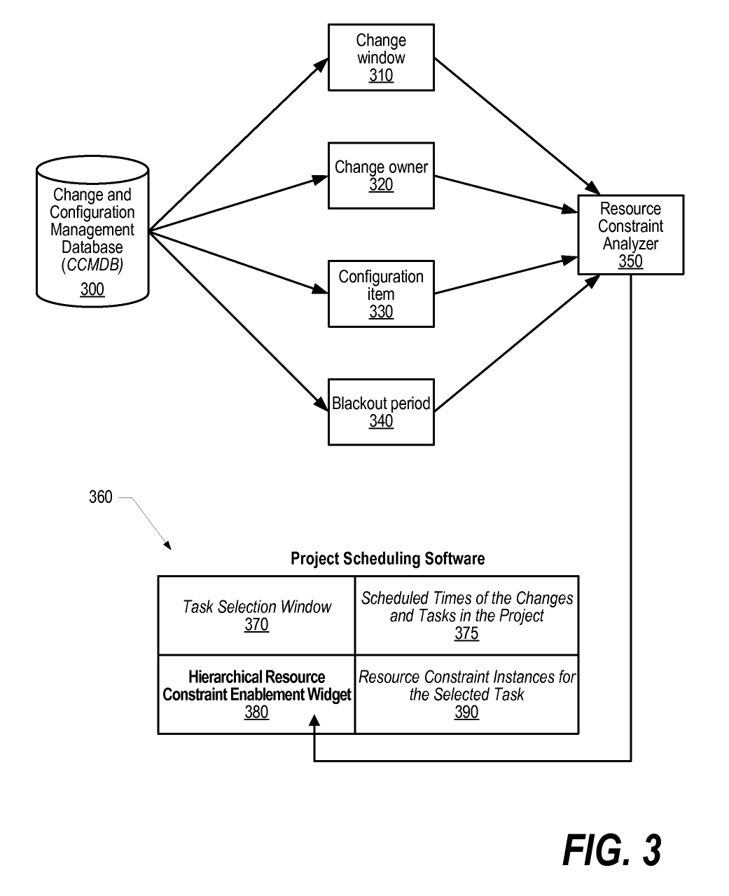

FIG. 3 is a component diagram showing data components analyzed from a change and configuration management database (CCMDB) to enable a hierarchical resource constraint enablement widget displayed to a user. CCMDB may include the IBM Tivoli Change and Configuration Management Database or any other software that may automate data, workflows, and/or policies to align IT infrastructure management with business priorities. Change and configuration management database (CCMDB) 300 is used to store, among other objects, constraint data pertaining to project tasks. A project task relates to a configuration change management project, such as the upgrading of a software package, etc.

Different types of constraint data are included in CCMDB 300. These types of constraint data include change window 310, such as the time period that has been assigned for changes to a system, change owner 320, such as the individual implementer that actually performs the change task, configuration item 330, and blackout period 340, such as a period of time where changes to a system are not to be performed. An example of a blackout period for a tax preparation organization might be the time period just before the date that taxes are due (e.g., April 15, etc.) as such period is likely to have heavy use of the system and changes during this period may be detrimental to the business.

Resource constraint analyzer 350 is a process that analyzes the various constraints pertaining to a task and informs the user as to whether the constraint is violated, not violated, or whether an exception has been provided to ignore a particular constraint. As used herein, if a constraint is violated it has a status of “Unavailable,” if a constraint is not violated it has a status of “Available,” and if a constraint exception has been approved for the constraint, then the constraint has a status of “Not in effect.”

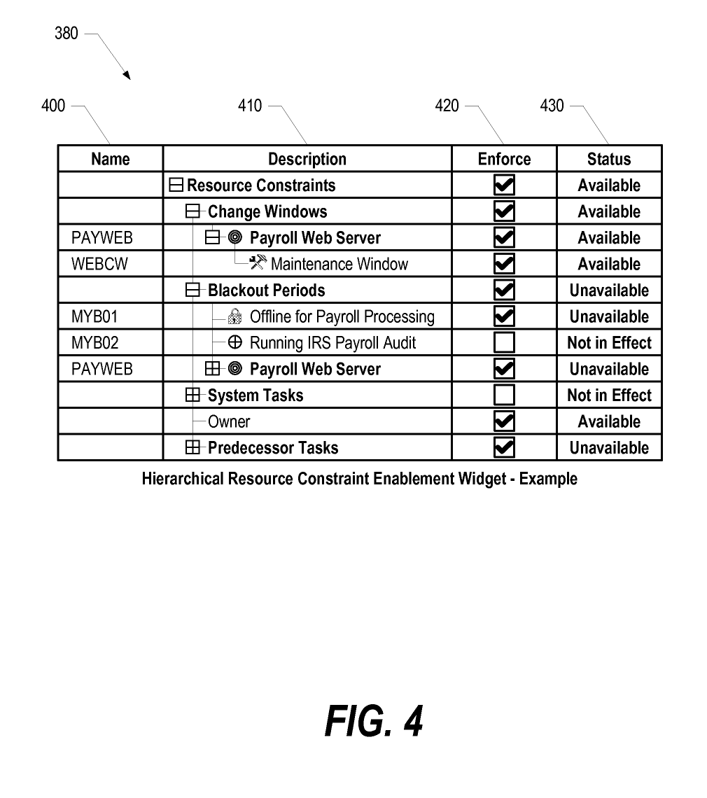

Project scheduling software 360 provides various windows that the user views and with which the user interacts in order to manage the project scheduling. Task selection window 370 displays a list of project tasks pertaining to a change management project and allows the user to select a project task with which the user wishes to work. When selected, data pertaining to the selected project task is displayed in windows 375, 380, and 390. Window 375 displays the scheduled times of the changes and tasks in the project. In one embodiment, window 375 allows the user to adjust the scheduled times which result in changes to the constraint comparisons that appear in window 380. Window 390 displays the resource constraint instances for the selected task. For example, blackout periods pertaining to the selected task would appear in window 390. Window 380 displays a hierarchical resource constraint enablement widget that pulls the various constraint data together in a display that allows the user to analyze and assess the various constraints that apply to the selected project task. FIG. 4 provides an example of data that might appear in window 380.

FIG. 4 is an example screen diagram of the hierarchical resource constraint enablement widget. In one embodiment, as shown in FIG. 3, this screen diagram is included as a window within a larger project scheduling program interface. Window 380 provides a number of data fields that provide the user with hierarchical resource constraint data. Four fields are shown in window 380. First, field 400 displays a Name of the displayed constraints. Second, field 410, displays a Description of the displayed constraints. In addition, a tree view is provided in the hierarchical display to expand and collapse nodes in the constraint hierarchy. Also, higher level constraints are actually constraint categories that are used as containers for categories of the same type. For example, Change Windows is a constraint category that includes Payroll Web Server which, in turn, includes a Maintenance Window. Blackout Periods is another constraint category that includes three blackout period constraints—Offline for Payroll Processing which is a blackout period when offline payroll processing is being performed, Running IRS Payroll Audit is a blackout period for when an IRS Payroll Audit is being executed, and Payroll Web Server is a blackout period pertaining to the Payroll Web Server. System tasks is a constraint category that is shown as collapsed. In one embodiment, the System tasks constraint category includes the various tasks that are currently scheduled for one or more computer systems (e.g., a servers) where the selected project task is currently installed and executing. Owner constraint pertains to tasks currently scheduled for the particular owner or person that is assigned to undertake the project task. In other words, the Owner constraint prevents an individual implementer from being scheduled to perform multiple tasks at the same time. Finally, Predecessor Tasks is a constraint category that is shown collapsed and contains predecessor tasks that are related to the selected project task (e.g., tasks that are to be performed before the selected task can be performed, etc.).

Enforce field 420 is a checkbox field that allows a constraint, or even a constraint category, to be selectively enforced or, if a constraint exception has been approved, disregarded. In one embodiment, the user of window 385 can select and de-select the enforce checkbox by clicking on the enforce field corresponding to a constraint or constraint category. In the example shown, the constraint of “Running IRS Payroll Audit” has been de-selected. In addition, the constraint category “System Tasks” has been de-selected. In other words, the constraints that would otherwise apply because of Running IRS Payroll Audit or other System Tasks do not apply (are Not in Effect) for the selected project task.

Status field 430 displays the status of each constraint. In one embodiment, the Status can either be “Available,” “Unavailable,” or “Not in Effect” based on the proposed time window with the proposed time window being the time period in which the selected task is to be performed as well as the Enforce checkbox. If a constraint is not in effect due to the Enforce checkbox being de-selected, then the status is “Not in Effect.” If a constraint is in effect but is satisfied based upon the proposed time window, then the status is “Available,” and if a constraint is in effect but is not satisfied based upon the proposed time window (constraint is violated), then the status is “Unavailable.” By reviewing the data displayed in window 380 the user can automatically or manually adjust the proposed time window and will see different status for the various constraints. In addition, the user can request constraint exceptions in order to have a constraint or constraint category not be in effect.

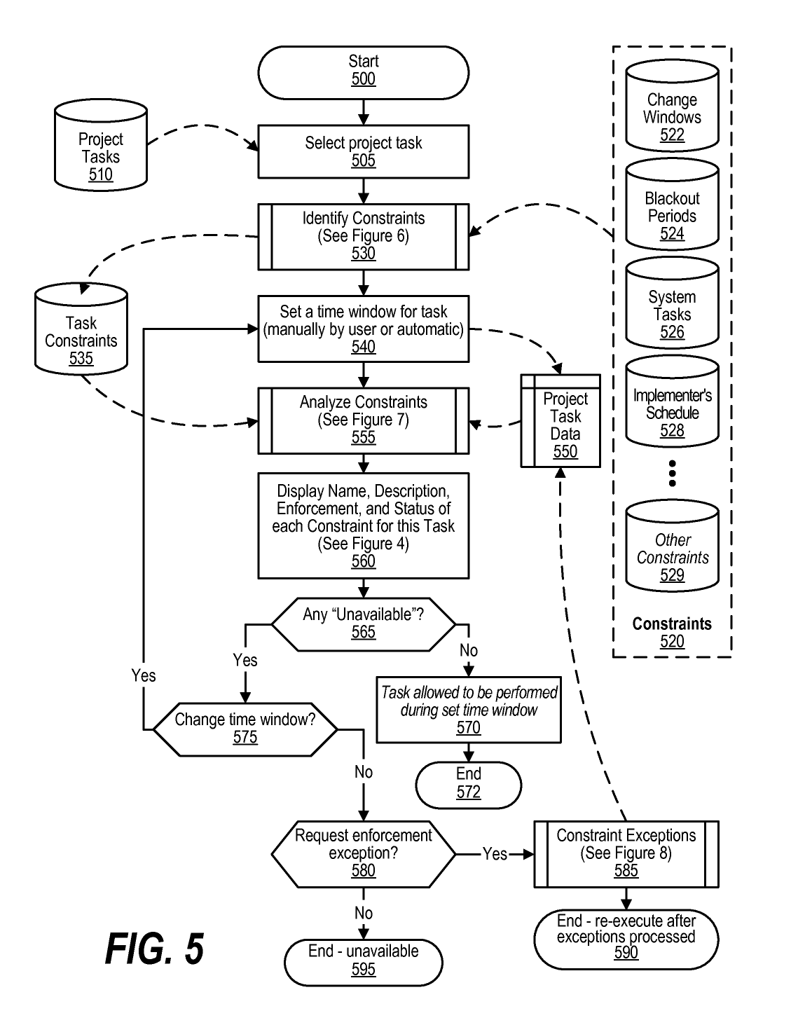

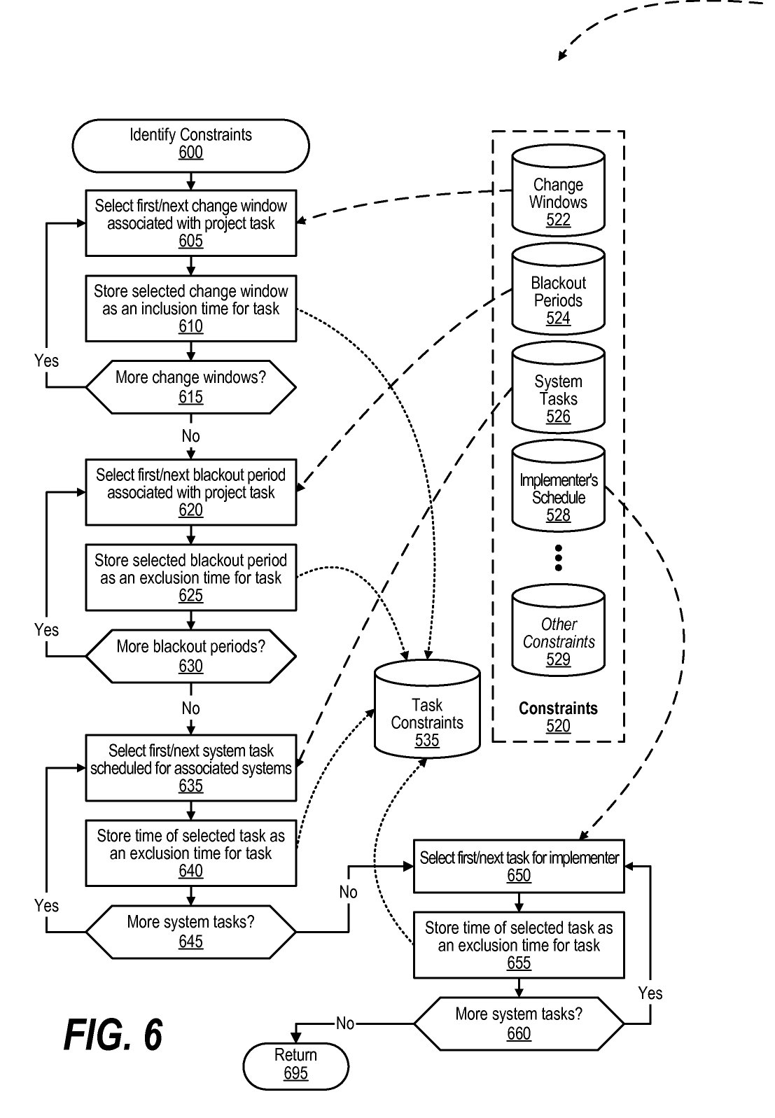

FIG. 5 is a flowchart showing the high level logic performed by the hierarchical resource constraint enablement widget. Processing commences at 500 whereupon, at step 505, the user selects a project task from project tasks data store 510 that includes the various project tasks corresponding to a change management project. At predefined process 530, constraints pertaining to the selected project task are identified by retrieving and analyzing constraint data stores 520 (see FIG. 6 and corresponding text for processing details regarding predefined process 530). In one embodiment, the constraint data stores include change windows 522, blackout periods 524, system tasks 526, implementer schedule 528, and other constraints 529. The constraints that apply to the task are stored in task constraints data store 535 which, in one embodiment, is a filter applied to the constraint data stores based upon the selected project task.

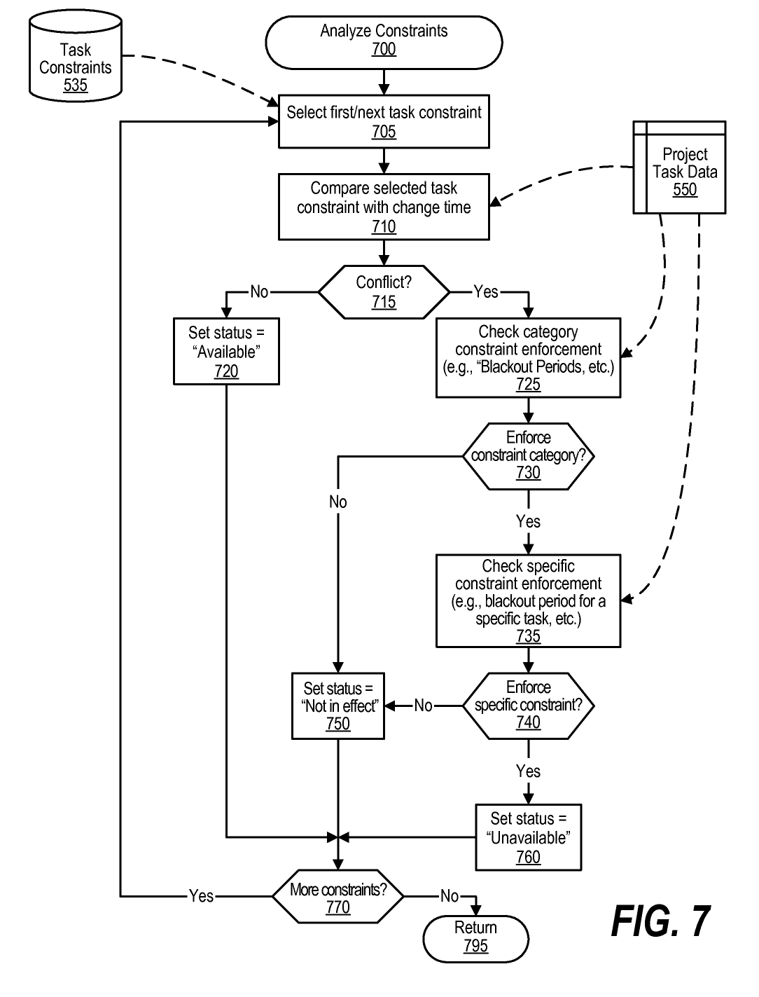

At step 540, a proposed time window is set either by the user or by an automated process that analyzes the current task constraints in order to identify a time window with fewer constraints. The proposed time window is saved in project task data 550, such as in a volatile or nonvolatile memory. At predefined process 555 the identified constraints are analyzed in light of the current proposed time window for the task as well as any constraint exceptions that have already been approved (see FIG. 7 and corresponding text for processing details). At step 560, after the constraints have been analyzed, the constraint name, constraint description, enforcement checkbox, and status of each constraint of the project task is displayed on a display screen (see FIG. 3 element 360 and FIG. 4, window 380 for example screen displays). A decision is made as to whether the status of any constraints is “Unavailable” indicating a conflict between the constraint and the proposed time window (decision 565). If none are unavailable, then decision 565 branches to the “no” branch whereupon, at step 570, the project task is allowed to be performed during the proposed time window and processing ends at 572.

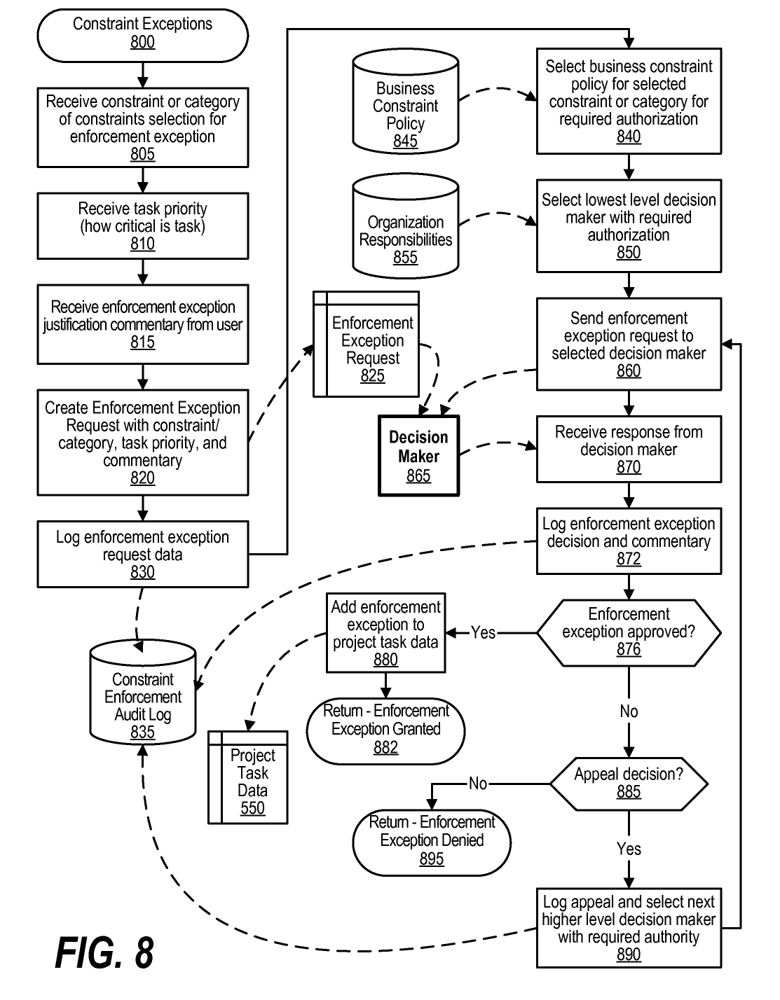

On the other hand, if one or more of the constraints are “Unavailable” indicating a conflict between the constraint and the proposed time window, then decision 565 branches to the “yes” branch whereupon a decision is made as to whether the user wishes to adjust the proposed time window (decision 575). If the user wishes to adjust the current time window, then decision 575 branches to the “yes” branch whereupon processing loops back to step 540 to receive the updated proposed time window and processing continues using the updated time window. On the other hand, if the user does not wish to change the proposed time window, then decision 575 branches to the “no” branch whereupon a decision is made as to whether the user wishes to request an enforcement exception of one or more of the constraints or constraint categories (decision 585). If the user wishes to request an enforcement exception, the decision 580 branches to the “yes” branch whereupon, at predefined process 585, the constraint exception is processed (see FIG. 8 and corresponding text for processing details) and processing ends at 590 with the steps shown in FIG. 5 being re-executed after the constraint exceptions have been processed. On the other hand, if the user does not wish to request constraint exceptions, then decision 580 branches to the “no” branch whereupon processing ends at 595 with one or more of the constraint status values being “Unavailable” indicating that the project task should not be performed during the proposed time window.

FIG. 6 is a flowchart showing the logic used to identify constraints within the hierarchical resource constraint enablement widget. Processing commences at 600 whereupon, at step 605, the first change window is identified that is associated with the selected project task by reading change windows data store 522 included in constraints data stores 520. At step 610, the selected change window is stored in task constraints data store 535 as an inclusion time for the selected task (a time in which the selected task can be performed). A decision is made as to whether there are more change windows to process (decision 615). If there are more change windows to process, decision 615 branches to the “yes” branch which loops back to select the next change window from change windows data store 522. This looping continues until all change windows associated with the selected project task have been selected, at which point decision 615 branches to the “no” branch.

At step 620, the first blackout period is selected that is associated with the selected task from blackout periods data store 524 included in constraints data stores 520. The selected blackout period is stored at step 625 as an exclusion time for the project task (a time in which the selected task should not be performed) in task constraints data store 535. A decision is made as to whether there are more blackout periods to process (decision 630). If there are more blackout periods to process, decision 630 branches to the “yes” branch which loops back to select the next blackout period from blackout periods data store 524. This looping continues until all blackout periods associated with the selected project task have been selected, at which point decision 630 branches to the “no” branch.

At step 635, the first system task is selected that is associated with the selected task from system task data store 526 included in constraints data stores 520. The selected system task is stored at step 640 as an exclusion time for the project task (a time in which the selected task should not be performed) in task constraints data store 535. A decision is made as to whether there are more system tasks to process (decision 645). If there are more system tasks to process, decision 645 branches to the “yes” branch which loops back to select the next system task from system tasks data store 526. This looping continues until all system tasks associated with the selected project task have been selected, at which point decision 645 branches to the “no” branch.

At step 650, the first implementer task is selected that is associated with the selected task from implementer task data store 528 included in constraints data stores 520. The selected implementer task is stored at step 655 as an exclusion time for the project task (a time in which the selected task should not be performed) in task constraints data store 535. A decision is made as to whether there are more implementer tasks to process (decision 660). If there are more implementer tasks to process, decision 660 branches to the “yes” branch which loops back to select the next implementer task from implementer tasks data store 528. This looping continues until all implementer tasks associated with the selected project task have been selected, at which point decision 660 branches to the “no” branch and processing returns to the calling routine (see FIG. 5) at 695.

FIG. 7 is a flowchart showing the logic used to analyze constraints performed by the hierarchical resource constraint enablement widget. Processing commences at 700 whereupon, at step 705, the first constraint associated with the selected project task is selected from task constraints data store 535. At step 710, the selected task constraint is compared with the proposed time window with the proposed time window being a time period in which the selected task is scheduled to be performed. The proposed time window is retrieved from project task data 550.

A decision is made as to whether the selected constraint conflicts with the proposed time window (decision 715). If the selected constraint does not conflict with the proposed time window, then decision 715 branches to the “no” branch whereupon, at step 720, the status of the constraint is set as “Available” indicating that the constraint is satisfied by the proposed time window. On the other hand, if there is a conflict, then decision 715 branches to the “yes” branch whereupon, at step 725, the category constraint enforcement is checked to determine whether the category of constraints (e.g., “Change Windows,” “Blackout Periods,” “System Tasks,” etc.) has an enforcement exception which applies to each constraint in the category. A decision is made as to whether the constraint category in which this constraint is a member is being enforced (decision 730). If the constraint category is being enforced, then decision 730 branches to the “yes” branch whereupon, at step 735, the specific constraint is checked to determine whether the specific constraint has an enforcement exception which has been approved. A decision is made as to whether the specific constraint is being enforced (decision 740). If the constraint category and the specific constraint are both being enforced, then decision 740 branches to the “yes” branch whereupon, at step 760, the status of the constraint is set to “Unavailable” indicating a conflict between the constraint and the proposed time window. On the other hand, if either a constraint category exception or a specific constraint exception apply, then a “no” branch is taken to step 750 which sets the status to “Not in effect” meaning that the constraint is not being enforced for the selected project task.

After the constraint has been processed, a decision is made as to whether there are more constraints to process (decision 770). If there are more constraints to process that pertain to the selected project task, then decision 770 branches to the “yes” branch which loops back to select the next constraint and processes it as described above. This looping continues until all constraints pertaining to the project task have been processed, at which point decision 770 branches to the “no” branch whereupon processing returns to the calling routine (see FIG. 5) at 795.

FIG. 8 is a flowchart showing the logic used to handle constraint exceptions within the hierarchical resource constraint enablement widget. Processing commences at 800 whereupon, at step 805, a constraint or constraint category is selected by the user for a possible enforcement exception. At step 810, a task priority is received from the user or from the task data that indicates the importance of the project task to the organization. At step 815, an enforcement exception justification, such as reasons why the exception should be granted, are received from the user. At step 820, enforcement exception request 825 is created with the constraint and/or constraint category, the task priority and the user-provided commentary. At step 830, the enforcement exception request data is logged in Constraint Enforcement Audit Log 835 for future audit purposes.

At step 840, a business constraint policy is selected from Business Constraint Policy data store 845. The business constraint policy corresponds to the selected constraint or constraint category for which an exception is being requested. For example, for a constraint exception, a project manager responsible for the business area may have to provide approval, while for a constraint category exception a higher level, such as a vice president of the business area, may have to provide approval. At step 850, the lowest level decision maker (e.g., project manager, vice president, etc.) is selected from Organization data store 855. At step 860, enforcement exception request 825 is sent to the selected decision maker 865.

At step 870, the process receives a response from the decision maker along with any commentary (e.g., reasoning, etc.) provided by decision maker 865. At step 872, the enforcement exception decision (grant exception, deny exception) is logged in Constraint Enforcement Audit Log 835 along with any commentary provided by the decision maker. A decision is made as to whether the decision maker approved (granted) the enforcement exception (decision 876). If the enforcement exception (either of a constraint or a constraint category) was accepted by the decision maker, then decision 876 branches to the “yes” branch whereupon, at step 880, the enforcement exception data is added to project task data 550 so that the “Enforce” checkbox corresponding to the constraint or constraint category will be unchecked. Processing returns to the calling routine (see FIG. 5) at 882.

On the other hand, if the enforcement exception was not approved, then decision 876 branches to the “no” branch whereupon a decision is made as to whether the user wishes to appeal the decision (decision 885). If the user wishes to appeal the decision denying the enforcement exception, then decision 885 branches to the “yes” branch whereupon, at step 890, the appeal of the decision is logged in Constraint Enforcement Audit Log 835 along with any additional commentary provided by the user and the next higher level (e.g., the first decision maker's supervisor, etc.) is selected. Processing then loops back to step 860 where the enforcement exception request is sent to the next higher level decision maker and is processed as described above.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method implemented by an information handling system comprising:
retrieving a project task from a nonvolatile data store wherein the project task corresponds to a configuration change management project;
identifying a plurality of constraints retrieved from a change and configuration management database (CCMDB) wherein each of the constraints are associated with the retrieved project task;
retrieving a proposed time window, wherein the proposed time window is a time period in which the retrieved task is scheduled to be performed;
retrieving one or more constraint exception values corresponding to one or more of the identified plurality of constraints;
comparing each of the plurality of constraint values with the proposed time window and the retrieved constraint exceptions, wherein the comparing results in a plurality of status values with each of the status values corresponding to one of the plurality of constraints; and
displaying the constraint and the corresponding status values on a display device.

2. The method of claim 1 wherein a subset of the retrieved plurality of constraints are included in a selected constraint category, and wherein the selected constraint category corresponds to one of the constraint exception values, the method further comprising:
identifying that the constraint exception value is set to allow a constraint exception of the selected constraint category; and
setting the status value of the selected constraint category to “not in effect” in response to the identified constraint exception value.

3. The method of claim 2 further comprising:
requesting a constraint category exception of the constraint category, the requesting further comprising:
identifying a business decision maker with authorization to approve the requested constraint category exception;
transmitting the requested constraint category exception to the identified business decision maker;
receiving an constraint category exception response from the identified business decision maker; and
setting the constraint exception value of the constraint category according to the received constraint exception response.

4. The method of claim 2 wherein at least one of the constraints included in the constraint category has the status value of “unavailable” in response to the comparison.

5. The method of claim 2 wherein each of the constraints is included in one of a plurality of constraint categories, wherein one of the plurality of constraint categories is the selected constraint category.

6. The method of claim 1 wherein one or more of the constraints are inclusion-type constraints and wherein one or more of the constraints are exclusion type constraints.

7. The method of claim 1 further comprising:
requesting a constraint exception of a selected one of the retrieved plurality of constraints, the requesting further comprising:
identifying a business decision maker with authorization to approve the requested constraint exception;
transmitting the requested constraint exception to the identified business decision maker;
receiving an constraint exception response from the identified business decision maker; and
setting the constraint exception value of the selected constraint according to the received constraint exception response.

8. An information handling system comprising:
one or more processors;
a memory coupled to at least one of the processors;
a nonvolatile storage device accessible by at least one of the processors;
a network interface that connects the information handling system to a network;
a display screen coupled to at least one of the processors; and
a set of computer program instructions stored in the memory and executed by at least one of the processors in order to perform actions of:
retrieving a project task from the nonvolatile storage device wherein the project task corresponds to a configuration change management project;
identifying a plurality of constraints retrieved from a change and configuration management database (CCMDB) wherein each of the constraints are associated with the retrieved project task;
retrieving a proposed time window, wherein the proposed time window is a time period in which the retrieved task is scheduled to be performed;
retrieving one or more constraint exception values corresponding to one or more of the identified plurality of constraints;
comparing each of the plurality of constraint values with the proposed time window and the retrieved constraint exceptions, wherein the comparing results in a plurality of status values with each of the status values corresponding to one of the plurality of constraints; and
displaying the constraint and the corresponding status values on the display screen.

9. The information handling system of claim 8 wherein a subset of the retrieved plurality of constraints are included in a selected constraint category, wherein the selected constraint category corresponds to one of the constraint exception values, and wherein the processors perform additional actions comprising:
identifying that the constraint exception value is set to allow a constraint exception of the selected constraint category; and
setting the status value of the selected constraint category to “not in effect” in response to the identified constraint exception value.

10. The information handling system of claim 9 wherein the processors perform additional actions comprising:
requesting a constraint category exception of the constraint category, the requesting further comprising:
identifying a business decision maker with authorization to approve the requested constraint category exception;
transmitting the requested constraint category exception to the identified business decision maker;
receiving an constraint category exception response from the identified business decision maker; and
setting the constraint exception value of the constraint category according to the received constraint exception response.

11. The information handling system of claim 9 wherein at least one of the constraints included in the constraint category has the status value of “unavailable” in response to the comparison.

12. The information handling system of claim 9 wherein each of the constraints is included in one of a plurality of constraint categories, wherein one of the plurality of constraint categories is the selected constraint category.

13. The information handling system of claim 8 wherein one or more of the constraints are inclusion-type constraints and wherein one or more of the constraints are exclusion type constraints.

14. A computer program product stored in a computer readable storage medium, comprising computer program code that, when executed by an information handling system, causes the information handling system to perform actions comprising:
retrieving a project task from a nonvolatile data store wherein the project task corresponds to a configuration change management project;
identifying a plurality of constraints retrieved from a change and configuration management database (CCMDB) wherein each of the constraints are associated with the retrieved project task;
retrieving a proposed time window, wherein the proposed time window is a time period in which the retrieved task is scheduled to be performed;
retrieving one or more constraint exception values corresponding to one or more of the identified plurality of constraints;
comparing each of the plurality of constraint values with the proposed time window and the retrieved constraint exceptions, wherein the comparing results in a plurality of status values with each of the status values corresponding to one of the plurality of constraints; and
displaying the constraint and the corresponding status values on a display device.

15. The computer program product of claim 14 wherein a subset of the retrieved plurality of constraints are included in a selected constraint category, and wherein the selected constraint category corresponds to one of the constraint exception values, the computer program product further comprising:
identifying that the constraint exception value is set to allow a constraint exception of the selected constraint category; and
setting the status value of the selected constraint category to “not in effect” in response to the identified constraint exception value.

16. The computer program product of claim 15 further comprising:
requesting a constraint category exception of the constraint category, the requesting further comprising:
identifying a business decision maker with authorization to approve the requested constraint category exception;
transmitting the requested constraint category exception to the identified business decision maker;
receiving an constraint category exception response from the identified business decision maker; and
setting the constraint exception value of the constraint category according to the received constraint exception response.

17. The computer program product of claim 15 wherein at least one of the constraints included in the constraint category has the status value of “unavailable” in response to the comparison.

18. The computer program product of claim 15 wherein each of the constraints is included in one of a plurality of constraint categories, wherein one of the plurality of constraint categories is the selected constraint category.

19. The computer program product of claim 14 wherein one or more of the constraints are inclusion-type constraints and wherein one or more of the constraints are exclusion type constraints.

20. The computer program product of claim 14 further comprising:
requesting a constraint exception of a selected one of the retrieved plurality of constraints, the requesting further comprising:
identifying a business decision maker with authorization to approve the requested constraint exception;
transmitting the requested constraint exception to the identified business decision maker;
receiving an constraint exception response from the identified business decision maker; and
setting the constraint exception value of the selected constraint according to the received constraint exception response.
